(19) United States
(12) Patent Application Publication
(10) Pub. No.: US 2014/0143309 A1
(43) Pub. Date: May 22, 2014

(54) NETWORK INTERFACE CARD AND METHOD FOR DISPLAYING INFORMATION OF NETWORK INTERFACE CARD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: YUE-HUA SHEN, Shenzhen (CN); FAN REN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/961,888

(22) Filed: Aug. 8, 2013

(30) Foreign Application Priority Data
Nov. 20, 2012 (CN) 2012104712415

(51) Int. Cl. H04L 12/24

(52) U.S. Cl. CPC H04L 41/22
USPC 709/203

(57) ABSTRACT

In a method for displaying information of a network interface card (NIC) in an electronic device, the NIC is configured with a display screen. When the NIC is activated, a request is transmitted to a dynamic host configuration protocol (DHCP) server for acquiring an Internet Protocol (IP) address. The IP address is received from the DHCP server, and displayed on the display screen of the NIC, which provides constant and convenient reference information for the benefit of a user.

### BACKGROUND

1. Technical Field

Embodiments of the present disclosure relate to information displaying technology, and particularly to a network interface card (NIC) and a method for displaying information of the NIC.

2. Description of Related Art

An electronic device may acquire an Internet Protocol (IP) address from a dynamic host configuration protocol (DHCP) server. However, the IP address has to be viewed by using a display device of the electronic device. When a plurality of electronic devices need to be connected to each other, each of the electronic devices has to be connected to a monitor for querying an IP address. When the electronic devices are host computers, which have no display device themselves, it is inconvenient and inefficient for people to check the IP addresses of each of the host computers. For example, people have to connect each of the host computers with the monitor, and then query each IP address of the host computers one by one using the monitor, by inputting a specific command. Therefore, an improved method for displaying information of the NIC is desired.

### BRIEF DESCRIPTION OF THE DRAWINGS

FIG. 1 is a block diagram of one embodiment of an electronic device including an NIC.

FIG. 2 is a block diagram of an information displaying system in the NIC.

FIG. 3 is a flowchart of one embodiment of a method for displaying information of the NIC using the information displaying system.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

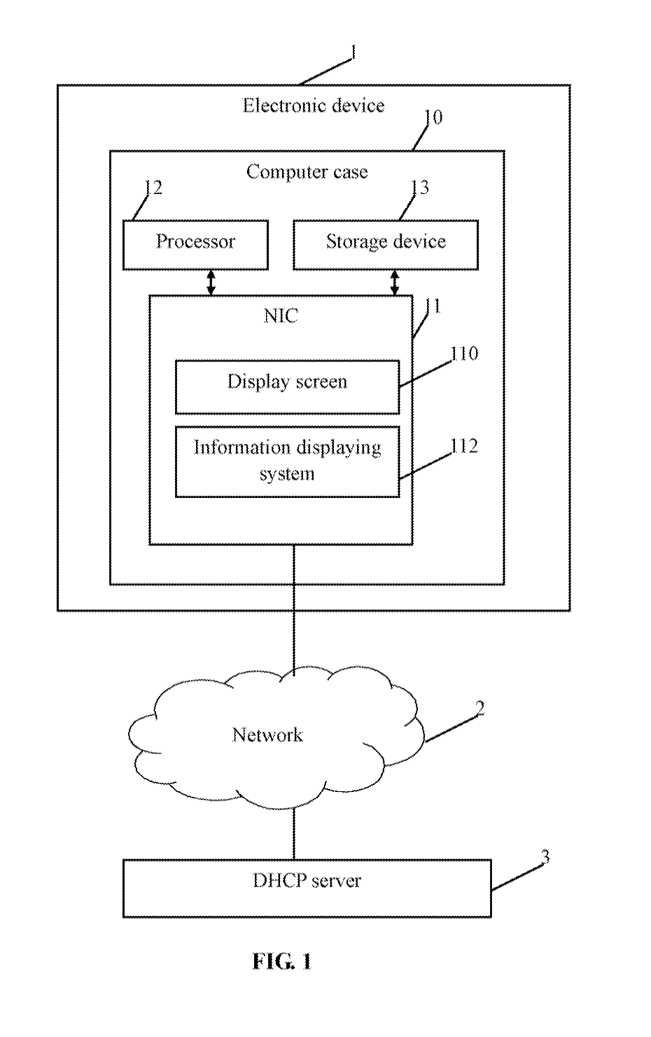

FIG. 1 is a block diagram of one embodiment of an electronic device 1 including a network interface card (NIC) 11. The electronic device 1 may be a host computer, a server, a rack server, or a portable electronic device, for example. In some embodiments, the electronic device 1 has a computer case 10, and the NIC 11 is installed in the computer case 10. The electronic device 1 may be connected to a peripheral display device (e.g., a monitor), or may have a display device that is configured on the electronic device 1, such as a tablet computer, for example.

The NIC 11 includes a display screen 110 and an information displaying system 112. Depending on the embodiments, the display screen 110 of the NIC 11 and the display device of the electronic device 1 are two different devices. The display screen 110 may be a mini display screen, and be located on a panel (e.g., a front panel, a side panel or a back panel) of the computer case 10.

The electronic device 1 is connected to a dynamic host configuration protocol (DHCP) server 3 through a network 2. The network 2 may be the Internet or other kind of communication network, such as the third generation (3G) telecommunication network, for example. The DHCP server 3 may allocate Internet Protocol (IP) addresses to different electronic devices that connected to the DHCP server 3. According to the IP addresses, the different electronic devices may communicate with each other and transmit data.

The information displaying system 112 may display an IP address acquired by the NIC 11 on the display screen 110, when the NIC 11 is activated (e.g., powered on). The display screen 110 is activated when the NIC 11 is powered on. That is, the IP address of the electronic device 1 may be viewed by a user through the display screen 110, without activating the display device of the electronic device 1 and without inputting any commands such as querying the IP address.

In other embodiments, the electronic device 1 has no computer case 10, and the NIC 11 is installed inside the electronic device 1.

The electronic device 1 further includes at least one processor 12 and a storage device 13. In other embodiments, the electronic device 1 may include more or fewer components than illustrated, or have a different configuration of the various components.

The information displaying system 112 may include computerized instructions in the form of one or more programs that are executed by the at least one processor 12 and stored in the storage device 13. In other embodiments, the NIC 11 my have an independent microprocessor embedded in the NIC 11 to execute the computerized instructions of the information displaying system 112, and an independent storage device to store one or more programs (e.g., the information displaying system 112) executed by the microprocessor.

The storage device 13 stores one or more programs, such as operating systems, applications of the electronic device 1, and various kinds of data. In some embodiments, the storage device 13 may be an external storage card, such as a memory stick, a smart media card, a compact flash card, a secure digital card, or any other type of memory storage device.

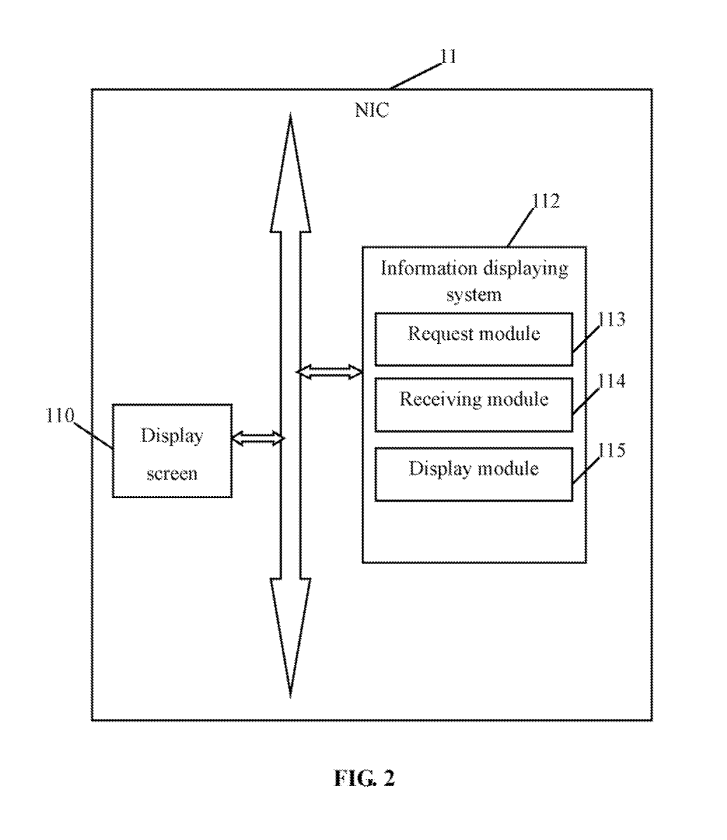

FIG. 2 is a block diagram of the information displaying system 112 in the NIC 11. The information displaying system 112 may include a request module 113, a receiving module 114, and a display module 115. In general, the word “module,” as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

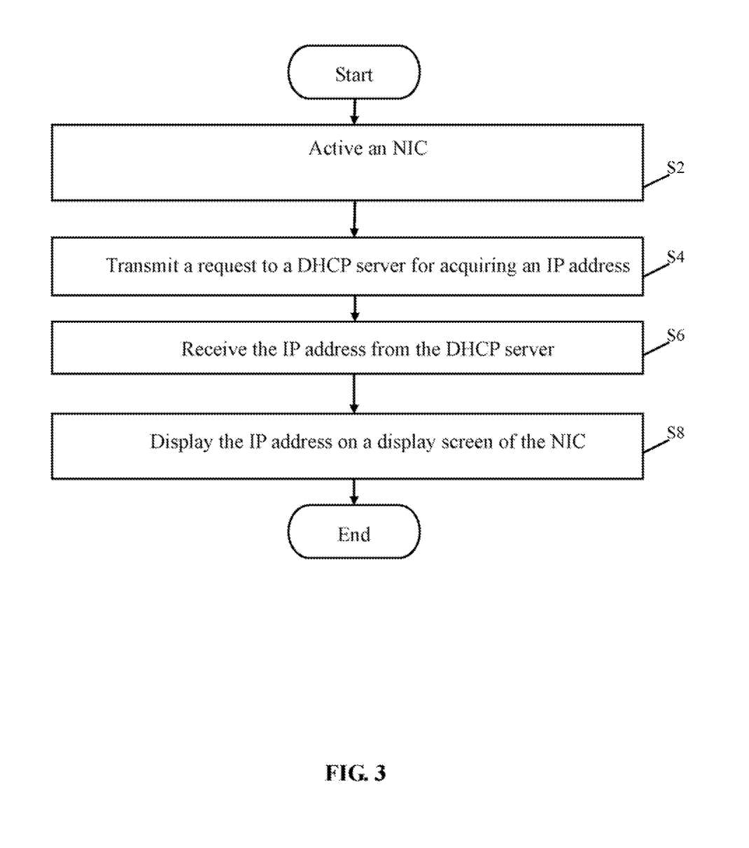

FIG. 3 is a flowchart of one embodiment of a method for displaying information of the NIC 11 using the information displaying system 112. Depending on the embodiment, additional steps may be added, others removed, and the ordering of the steps may be changed.

In step S2, the NIC 11 is activated (e.g., powered on) when the electronic device 1 or the computer case 10 is powered on.

In step S4, the request module 113 transmits a request to the DHCP server 3 for acquiring an IP address of the electronic device 1.

In step S6, the receiving module 114 receives the IP address from the DHCP server 3. If no IP address is received from the DHCP server 3, the display module 115 displays a failure message on the display screen 110, and the request module 113 resends the request to the DHCP server 3.

In step S8, the display module 115 displays the IP address on the display screen 110 of the NIC 11.

In other embodiments, the display module 115 further displays parameters of the NIC 11 on the display screen 110. The parameters may include, but are not limited to a bandwidth, a network speed and a type (e.g., the Internet or an intranet) of a network that the NIC 11 is currently connected to, a state (e.g., a dynamic state or a static/sleep state) of the NIC 11, and information of connections between the NIC 11 and the other NICs of other electronic devices.

In other embodiments, the electronic device 1 has more than one NIC 11, which may share the display screen 110 to display more than one IP addresses. Also, each of the more than one NICs 11 may have an independent display screen 110.

It should be emphasized that the above-described embodiments of the present disclosure, particularly, any embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented method for displaying information of a network interface card (NIC), the method comprising:
transmitting a request to a dynamic host configuration protocol (DHCP) server for acquiring an Internet Protocol (IP) address when the NIC is activated, the NIC being configured with a display screen;
receiving the IP address from the DHCP server; and
displaying the IP address using the display screen of the NIC.

2. The method according to claim 1, further comprising:
displaying parameters of the NIC on the display screen.

3. The method according to claim 2, wherein the parameters of the NIC comprise a bandwidth, a network speed and a type of a network that the NIC is connected to, a state of the NIC, and information of connections between the NIC and the other NICs.

4. The method according to claim 1, wherein the electronic device has more than one NIC, which share a same display screen or each has an independent display screen.

5. A network interface card (NIC) comprising:
a display screen;
at least one processor; and
a storage device storing a plurality of instructions, which when executed by the processor, causes the at least one processor to:
transmit a request to a dynamic host configuration protocol (DHCP) server for acquiring an Internet Protocol (IP) address when the NIC is activated;
receive the IP address from the DHCP server; and
display the IP address on the display screen of the NIC.

6. The NIC according to claim 5, wherein the at least one processor further displays parameters of the NIC on the display screen.

7. The NIC according to claim 6, wherein the parameters of the NIC comprise a bandwidth, a network speed and a type of a network that the NIC is connected to, a state of the NIC, and information of connections between the NIC and the other NICs.

8. The NIC according to claim 5, wherein the electronic device has more than one NIC, which share a same display screen or each has an independent display screen.

9. A non-transitory storage medium having stored thereon instructions that, when executed by a processor of a network interface card (NIC), causes the NIC to perform a method for displaying information of the NIC, the method comprising:
transmitting a request to a dynamic host configuration protocol (DHCP) server for acquiring an Internet Protocol (IP) address when the NIC is activated, the NIC being configured with a display screen;
receiving the IP address from the DHCP server; and
displaying the IP address using the display screen of the NIC.

10. The non-transitory storage medium according to claim 9, wherein the method further comprises:
displaying parameters of the NIC on the display screen.

11. The non-transitory storage medium according to claim 10, wherein the parameters of the NIC comprise a bandwidth, a network speed and a type of a network that the NIC is connected to, a state of the NIC, and information of connections between the NIC and the other NICs.

12. The non-transitory storage medium according to claim 9, wherein the electronic device has more than one NIC, which share a same display screen or each has an independent display screen.
